(19) United States
(12) Patent Application Publication
(10) Pub. No.: US 2017/0200244 A1
(43) Pub. Date: Jul. 13, 2017

(54) Systems and Techniques for Integrating Electronic Signature Platforms with Social Messaging Applications for Authenticated Electronic Documents

(71) Applicant: Adobe Systems Incorporated, San Jose, CA (US)

(72) Inventors: Shilpi Aggarwal, New Delhi (IN); Sourabh Goel, New Delhi (IN)

(21) Appl. No.: 14/990,147

(22) Filed: Jan. 7, 2016

(51) Int. Cl. G06Q 50/18; H04L 12/58

(52) U.S. Cl. CPC G06Q 50/18; H04L 51/04; H04L 51/32

(57) ABSTRACT

Systems and methods disclosed herein generate an authenticated electronic document from direct messages passed between participants in a social messaging application, such as direct messages in an instant messaging application or in a chain of emails. An electronic signature application executing on a mobile or desktop device receives conversation information from the social messaging application and parses the conversation information to extract a chronological list of direct messages between participants and metadata associated with the messages. The chronological list of direct messages specify the terms of an agreement discussed over instant messaging or over email. The electronic signature application communicates the chronological list of direct messages and the metadata associated with the messages with an electronic signature server over a network to generate an authenticated electronic document. The authenticated electronic document is stored in a database for preservation and copies are transmitted to the participants of the agreement.

### TECHNICAL FIELD

This disclosure relates generally to computer-implemented methods and systems and more particularly relates to configuring electronic communications for generating authenticated electronic documents.

### BACKGROUND

Electronic signature platforms provide enterprise entities as well as individual users the ability to generate authenticated documents electronically signed by all of the required parties. In an electronic signature workflow, an author creates an agreement or a portion of an agreement via a word processing application and distributes it over an electronic network to other geographically dispersed participants in the agreement creation. An electronic signature server coordinates the communication between the participants. Once an agreement drafted in a word processing application is completed, one of the participants transmits an electronic version of the document to an electronic signature server. The electronic signature server coordinates receiving the electronic signatures from the participants and storing the authenticated electronic document in a database for preservation and later retrieval. While the electronic signature process allows participants in geographically dispersed locations to generate authenticated electronic documents, the process for manually drafting electronic documents specifying terms of an agreement is a cumbersome task that is time consuming and inefficient. It is inconvenient to generate a document using a word processing application, communicate the document to other participants and wait for any potential revisions to the agreement from the other participants, and upload the final document to an electronic signature server.

In contrast, a plethora of other electronic communication platforms provide almost instant communication between geographically dispersed participants. These additional electronic communication platforms include social messaging applications such as instant messaging applications and e-mail, both on mobile applications and on desktop devices. Because of the ease of communication, conversations on social messaging applications are starting to expand from personal communication to business oriented communications. In some instances, business transactions occur over social messaging applications. For example, the terms of a business agreement are sometimes discussed over direct messages passed in an instant messaging application. However, current electronic signature platforms do not provide for capturing the authenticity of business transactions that occur over instant messaging applications and email. There is no mechanism for electronically signing conversations over social messaging applications to authenticate the conversations. Thus, there is currently no mechanism to verify the identity of participants in an electronic messaging or email conversation. Further, communication over social messaging applications is transient in nature. Once an instant messaging application is closed or an email deleted, any conversations discussed (and consequently any business agreements reached) during the instant messaging or email sessions are lost. For an authenticated electronic document, the captured conversations between participants need to be preserved and reproducible by any of the participants at any given time. The transient and insecure nature of social messaging applications, both on mobile and desktop devices, makes it difficult to authenticate, add necessary legal provisions, and later reproduce electronic documents discussed over direct messages passed via instant messaging or email. To generate an authenticated agreement discussed over a social messaging application, participants first have to manually convert the direct messages passed within the social messaging application to a word processing document, and then upload the word processing document to an electronic signature service for authentication. Not only is this time consuming and inefficient, but the original electronic conversation that took place within the social messaging application is not preserved for later retrieval. There is a need integrating providing electronic document signing solutions with conversations generated via social messaging applications such as instant messaging and email.

### SUMMARY

Systems and methods disclosed herein provide for generating authenticated electronic documents from direct messages passed between participants of a social messaging application, such as an instant messaging application or an email application. Participants of an agreement frequently discuss the terms of an agreement via direct messages in the social messaging applications. The embodiments disclosed herein allow geographically dispersed participants of an agreement to discuss the terms of the agreement over an electronic network via direct messages that are transmitted and received almost instantaneously. The chronological list of direct messages in a social messaging application capture the entire back and forth negotiations and discussions between the participants. Previous methods to draft, negotiate, and execute electronic documents required drafting or transcribing any discussions between participants (that may have occurred over instant messaging or email) within a word processing document, and then transmitting the word processing document to the other participants to make further edits in case the draft word processing document did not capture the original terms discussed. Embodiments disclosed herein enable participants to directly capture, authenticate, and preserve the terms discussed over instant messaging or via email without having to manually redraft the terms into a word processing application.

A social messaging application executing on a user's mobile or desktop device interfaces with the social messaging application via an interface (e.g., an application programming interface (API)). The interface exposes methods and functions of the social messaging application that allow other applications to retrieve electronic data from the social messaging application. Via the interface, an electronic signature application executing on the mobile or desktop device retrieves conversation information from the social messaging application. The conversation information includes a chronological list of direct messages passed between participants of the conversation as well as metadata identifying the time the messages were transmitted, contact information of the participants, and other associated information.

In some embodiments, the electronic signature application presents a user interface for deleting or otherwise modifying one or more of the chronological list of direct messages (e.g., one or more of the chronological list of direct messages that are irrelevant to the terms of the agreement). The original list of direct messages and the modified list of direct messages (along with associated metadata) are transmitted to an electronic signature server over a network. The electronic signature server generates an electronic document from the received conversation information by converting the original list or modified list of direct messages to an electronic document format, such as a PDF. The generated PDF lists the direct messages specifying the terms of the discussed agreement, timestamps of the messages, identities of the participants of the conversation, and/or contact information for the participants. The electronic signature server also inserts legal provisions to the electronic document. The inserted legal provisions are in some aspects preconfigured, predetermined and stored in memory of the electronic signature server so that the electronic signature server can insert the provisions when generating electronic documents. The electronic signature server also inserts in the electronic document participant contact information and a signature portion for the participants (e.g., at the end of the list of direct messages specifying the terms of the agreement, a signature section is inserted).

Upon generating the electronic document, the electronic signature server transmits the unsigned document to the participants. For example, the unsigned electronic document is transmitted to the email addresses of the participants or to the electronic signature applications executing on the computing devices of the participants. Upon receiving electronic signatures from the participants (e.g., user name and passwords, biometric identification, or other methods of user identification), the electronic signature application and electronic signature server communicate to authenticate the identities of the participants. The signed, authenticated electronic document is stored at a database by the electronic signature server for preservation.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 is a block diagram depicting an example of a system for generated authenticated electronic documents from direct messages passed between participants in a social messaging application, according to certain embodiments.

FIG. 2 is a diagram depicting an example of conversation information provided from a social messaging application, such as an instant messaging application, to an electronic signature application, according to certain embodiments.

FIG. 3 is a flowchart illustrating an exemplary method for generating an authenticated electronic document from direct messages passed between participants in a social messaging application, according to certain embodiments.

FIG. 4 is a flowchart illustrating an alternate method for generating an authenticated electronic document from direct messages passed between participants in a social messaging application, according to certain embodiments.

FIG. 5 is a block diagram depicting example hardware implementations for the components described in FIG. 1.

### DETAILED DESCRIPTION

Computer-implemented systems and methods are disclosed for generating authenticated electronic documents from conversations between participants in a social messaging application. The social messaging application includes any application in which participants communicate using direct messages. For example, the social messaging application includes instant messaging applications in which direct messages are passed almost instantaneously in real time over an electronic network to a recipient. The social messaging application also includes an email application. Currently, no mechanism exists for capturing and authenticating terms of an agreement discussed in a social messaging application over an electronic network.

Embodiments disclosed herein enable a social messaging application to integrate with the electronic signature platform to generate an electronic document and authenticate the identities of the participants of the agreement. The electronic signature platform also stores the resulting authenticated electronic document for preservation and later retrieval. To integrate a social messaging application with an electronic signature platform, an electronic signature interface between the social messaging application and the electronic signature platform exposes the messages and related metadata passed between participants within the social messaging application to the electronic signature platform. In one embodiment, an example of an electronic signature interface between the social messaging application and the electronic signature platform is an application programming interface (API). The electronic signature platform retrieves and parses the messages and related metadata to automatically generate an electronic document that captures the messages between the participants that carry terms of an agreement.

The electronic signature platform includes an electronic signature server and one or more instances of an electronic signature application. To provide identity authentication and electronic signature services of electronic documents on the electronic platform, the electronic signature server communicates with the instances of an electronic signature application executing on one or more client computing devices. The electronic signature server also preserves the messages between participants in the social messaging application and potentially other information relevant to the agreement and stores the electronic document in a database for later retrieval.

For example, the electronic signature application captures the messages comprising the conversations within the social messaging application in chronological order, the timestamps of the messages, the contact information for the participants, as well as other metadata. The messages between participants of the social messaging application include text data (i.e. messages typed out on instant messaging windows or email applications), audio data, video data, or attachments. Thus, embodiments herein provide for capturing and authenticating electronic agreements discussed within social messaging application while in any mode of communication (e.g., via text and data entry, audio conference, video conference, etc.).

For example, in one embodiment, participants input edits to an agreement using a keyboard, touch screen, or other input device for entering text. The text and relevant metadata are captured from within the social messaging application in chronological order. In another embodiment, in addition to or instead of text entry, a participant attaches an image or other file (e.g., an image or other file depicting the contents of the electronic agreement). The participants are further presented with an option to select the image surrounding messages as part of the agreement. The electronic signature application captures the conversation information in the attached image by, for example, image processing techniques or by including the image attachment with the chronological list of messages that are captured. In another embodiment, in addition to the above, the participants engage in a video or audio conference within the social messaging application. For example, the social messaging application presents an option for initiating a voice or video conference with one or more of the other participants. During the audio or video conference, the participants discuss and make edits to an agreement. Once the video or audio conference ends and a participant enters an input for capturing the messages comprising the conversations, the electronic signature application captures the conversation from the audio or video conference by speech recognition techniques or by including the audio data with the chronological list of direct messages that are captured.

Embodiments discussed herein allow an electronic signature application to capture the entire instance of the conversation between participants that took place within a social messaging application. For example, in one instance of the social messaging application conversation, participants discuss terms of an agreement by entering text data as messages, by including attachments, and by engaging in an audio conference. The electronic signature application captures all data as provided via text entry, attachments, and audio entry as described above. Taking an example, consider two participants of a social messaging application X and Y that are conversing. In this example, the social messaging application is an instant messaging application:
X. I want to reach an agreement on the sale deed.
Y: okay what are the changes you want to the last version I am providing below.
Y then posts an image in the social messaging application as an attachment.
X: Let us change date in clause A from December 22 to January 21. Also, there are some other minor changes which will be quick to discuss over call,
X then calls Y using an audio conference feature of the social messaging application.
X suggests few changes to which Y agrees and then the audio chat instance ends.

Participant X then selects an option to convert the messages from the conversation into an agreement. Options are provided to participant X to select the image attachment and the audio conversation as part of the agreement. This is done by using, for example, image processing and speech recognition or by including the image and voice recording in the electronic agreement without any conversion of image and recording to text. Thus, in the example above, the electronic signature application captures, from the social messaging application, messages that contain text entry, file attachments, and audio data in which the participants discussed various terms of the agreement.

As not all of the messages in the social messaging application may be relevant to the agreement that needs to be authenticated and signed, participants are presented with the option to modify or delete one or more of the individual messages captured from the social messaging application. The electronic signature application transmits the original conversation and the modified conversation to an electronic signature server. The electronic signature server uses the modified conversation data to generate an electronic document that incorporates the modifications of the participants. In one embodiment, the electronic signature server also automatically adds necessary legal provisions to the electronic document. In one embodiment, the electronic signature server further automatically adds the signature fields for the participants to the modified electronic document.

In one embodiment, the electronic signature server authenticates the identities of the participants to generate a signed authenticated electronic document. Such authentication involve one or more appropriate authentication techniques. In one example, the electronic signature server transmits an email to registered email addresses of the participants, the email including a link to the electronic document for signature. Other options for authentication and signing include authenticating with the electronic signature server via a password or PIN, a biometric signature, or any other suitable method for electronic authentication and signing.

Upon receiving the electronic signatures of the participants for the electronic document, the electronic signature server stores both the authenticated electronic document (as modified by the participants and electronically signed) and the unmodified, original set of conversation data in a database of the electronic signature server.

By integrating the social messaging application with an electronic signature platform via the electronic signature application as described above, participants have the ability to automatically capture communication that takes place within the social messaging application and generate a signed electronic document authenticated by the electronic signature platform. By converting conversations from a social messaging application to an authenticated electronic document using embodiments disclosed herein, the invention significantly improves the efficiency and workflows for participants negotiating and generating the electronic documents because the participants no longer need to manually redraft discussions that took place on instant messaging or email into separate word processing documents. The participants are also able to retrieve stored agreements at any point in time, thus eliminating the problem posed by the transient nature of instant messaging and email communications.

As used herein, the term “conversation” refers to a grouping of direct electronic messages passed between participants in an email chain or as a grouping of instant messages in an instant messaging application. In some aspects, a conversation includes a chronological list of direct messages and metadata associated with the direct messages. The metadata indicates the identities of the participants of the conversation, the specific times the direct messages were transmitted, and any media (e.g., image, video, or audio files) that accompany the direct messages.

As used herein, the term “social messaging application” refers to any application in which participants communicate using direct messages over a network. Social messaging applications include, for example, instant messaging application where messages are transmitted between computing devices as real-time text and data transmissions over the network almost instantaneously. Real-time text and data transmissions also include transmissions in which the electronic signals carrying the text or data arrive at the destination computing device after a period of time due to, for example, network congestion, bandwidth limitations, and other technical limitations that prevent instantaneous communication. Social messaging applications also include email applications, either as email client applications executing on a computing device or as online email services.

As used herein, the term “direct message” refers to electronic text and data messages passed between participants of a social messaging application, including text messages and instant messages and email messages. The text and data messages comprising a direct message include text data, audio data, video data, and attached files (e.g., image attachments, word processing attachments, PDF attachments, etc.).

As used herein, the term “electronic document” refers to electronic media content that comprises the chronological list of direct messages between participants of an agreement discussed over a social messaging application. An electronic document includes electronic media content that is presentable and readable on a computer interface. Examples of an electronic document includes electronic content in a portable document format (PDF), a word processing document, and other electronic content that displays the chronological list of direct messages.

As used herein, the term “authenticated electronic document” refers to an electronic document that has been authenticated by verification of the identities of the participants/authors of the electronic document.

As used herein, the term “signature space” refers to a region of the electronic document reserved for listing the names of the participants/authors of the electronic agreement. The signature space, in some embodiments, includes a further section for displaying the electronic signatures of the participants in an authenticated electronic document.

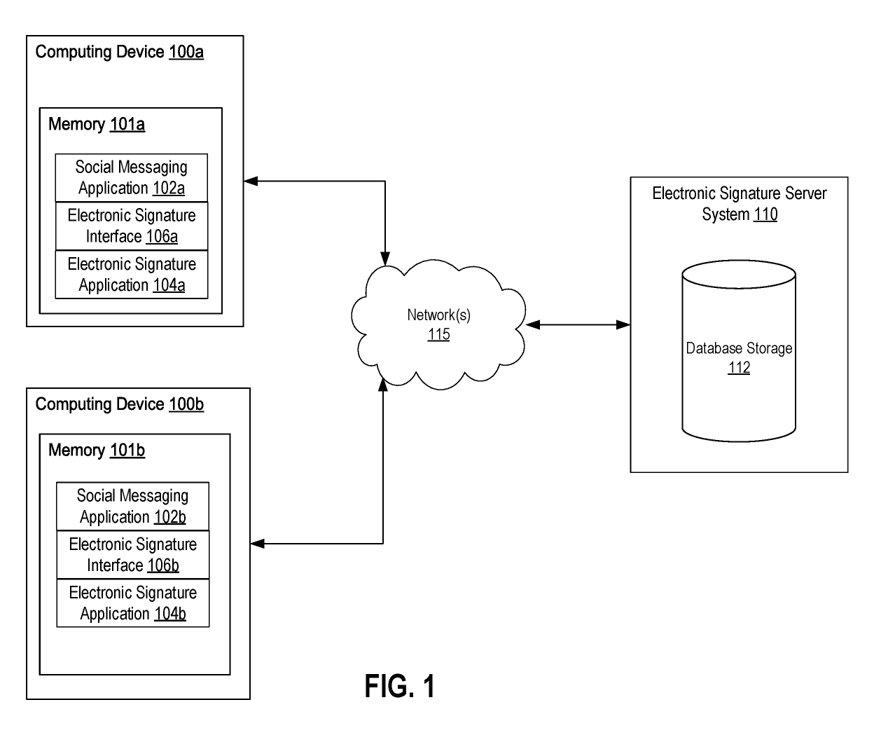

Referring now to the drawings, FIG. 1 is a block diagram depicting a computing environment in which an electronic signature server system 110 interfaces with computing devices 100a-b to provide authenticated electronic documents from direct messages passed between participants via social messaging applications 102a-b. Specifically, users of computing devices 100a-b transmit and receive direct messages discussing the terms of an agreement via social messaging applications 102a-b. Computing devices 100a-b include, but are not limited to, mobile devices such as mobile phones and tablet computers as well as desktop computers. Electronic communications between computing devices 100a-b are transmitted over network 115. Network 115 includes the Internet and also includes local intranets or other suitable communication networks. Computing devices 100a-b include memory devices 101a-b that store program code for any applications, such as social messaging applications 102a-b. Computing devices 100a-b also execute electronic signature applications 104a-b, which provide the interface between social messaging application 102a and the electronic signature server system 110.

The electronic signature server system 110 includes one or more computer servers that provide electronic signature and authentication services to connected client computing devices 100a-b. For example, the electronic signature server system 110 authenticates the identities of the participants that provide an electronic document to the electronic signature server system 110. The electronic signature server system 110 stores, in a memory device (not shown in FIG. 1), unique identifiers for the users of computing devices 100a-b. Identifiers include email addresses, biometric identification (e.g., fingerprint identifiers or iris scan identifiers for the users), and other standard electronic identifiers. The electronic signature server system 110 communicates with the electronic signature applications 104a-b via network 115 to authenticate the identities of the participants of any received electronic document. To perform the authentication, users of the computing devices 100a-b provide identification information (e.g., username and password, email address, biometric reading, etc.) to the electronic signature applications 104a-b, and the electronic signature applications 104a-b transmit the identification information to the electronic signature server system 110. The electronic signature server system 110 cross-references the received identification information with the stored unique identifiers to authenticate the users.

The electronic signature server system 110 includes or is communicatively coupled to a database storage 112. Database storage 112 includes any media storage device, such as a hard disk drive, flash drive, network attached storage device, and other storage media. While database storage 112 is shown as included in the electronic signature server system 110, in other aspects the database storage 112 is remote from and communicatively coupled to the electronic signature server system 110. The electronic signature server system 110 stores authenticated electronic documents, unique user identifiers, and other data within the database storage 112.

As discussed above, the social messaging applications 102a-b include any application that users of computing devices 100a-b use to communicate using direct messages passed over network 115. For example, participants of an agreement (i.e. users of computing devices 100a-b) discuss terms and conditions of the agreement over an instant messaging application, where messages are transmitted between computing devices 100a-b as real-time text and data transmissions over network 115. In an instant messaging application, a direct message transmitted from computing device 100a is received by computing device 100b almost instantaneously (any delay is a result of standard network transit latency for electronic communication between geographically dispersed devices). Participants of an agreement also discuss terms and conditions via a chain of direct messages passed in an email conversation.

To generate an authenticated electronic document for direct messages passed between participants using social messaging applications 102a-b, once the conversation discussing the terms of the agreement is complete (i.e. once all participants have provided direct messages via social messaging application 102 and terms and conditions are complete), the electronic signature application 104 retrieves conversation information from social messaging application 102. In some embodiments, the electronic signature application 104 continually captures the direct messages passed between participants as a background process as the direct messages are passed between the participants (e.g., if the user indicates an intent at the beginning or during the conversation to capture messages within the electronic signature application 104). The retrieval of the conversation data begins either within the social messaging application 102a (i.e. when the social messaging application 102a is in the foreground of the computing device 100a and actively executing) or within the electronic signature application 104 (i.e. when the electronic signature application 104 is within the foreground of the computing device 100a).

For example, in one embodiment, a user interface of the social messaging application 102a presents options for transferring the completed conversation data to the electronic signature application 104. In one aspect, a user interface element (e.g., a “share data” button or similar user interface element) is presented on the user interface of the social messaging application 102a, the selection of which presents other potential applications that can receive data from the social messaging application 102a. One of the potential applications displayed is electronic signature application 104. The electronic signature application 104 is configured to listen for a custom action originating from the social messaging application 102a. Upon selection of the user interface element for sharing data and the selection of the electronic signature application 104 from the list of potential applications, the computing device 100a transmits the conversation information on the direct messages describing the terms of the agreement from social messaging application 102a to electronic signature application 104.

Conversation information is transmitted from the social messaging application 102 to electronic signature application 104 via an electronic signature interface 106. Various software interfaces are possible for implementing electronic signature interfaces 106a-b. In one embodiment, the electronic signature interface 106 between the social messaging application 102 and the electronic signature application 104 is an API that exposes certain functions and commands for outputting data from social messaging application 102a to another application (i.e. electronic signature application 104). In other embodiments, the electronic signature interface 106 between the social messaging application 102 and the electronic signature application 104 is a plugin for the social messaging application. In other embodiments, the social messaging application 102 includes the electronic signature interface 106 and provides native support for sharing data with the electronic signature application 104 (in other words, the application program code for the social messaging application 102 natively supports outputting conversation information to other applications on the computing device 100).

In another embodiment, upon completing the conversation, the user of computing device 100a exits or otherwise minimizes executing social messaging application 102a to the background and launches electronic signature application 104a. Electronic signature application 104a presents an option via a user interface element to import conversation data from social messaging application 102a. Via a similar interface as described above, electronic signature application 104a retrieves the electronic conversation information from the social messaging application 102a and presents the conversation data (i.e. chronological list of direct messages) on the user interface.

In one embodiment, multiple conversations are received by the electronic signature application 104a from the social messaging application 102a. For example, participants may provide direct messages discussing terms of an agreement during different times and during different conversation (i.e. terms of an agreement may be spread out in different groups of instant messages or different email chains). Electronic signature application 104a further provides a user interface for receiving selections from user of computing device 100a to specify the conversations that should be used to generate the electronic document. In one aspect, the user specifies the start and end times of the relevant conversation and the electronic signature application 104 filters the chronological list of direct messages in the conversation data to display the time limited conversations.

Upon receiving the conversation information from the social messaging application 102a, the electronic signature application 104a can receive further inputs from the user of computing device 100a for modifying or deleting one or more direct messages from the chronological list of direct messages. For example, in an instant messaging or email communication chain, one or more messages passed between participants may not be relevant to the subject matter of the electronic document being discussed. The electronic signature application 104 thus presents a user interface to remove or modify one or more of the irrelevant messages from the chronological list of direct messages. Deletions made by one participant may be presented to one or more other participants to confirm that the deletions are appropriate.

Upon receiving a selection identifying the conversation and inputs modifying the chronological list of direct messages in the conversation, the electronic signature application 104 parses the edited conversation to identify a final set of messages and related metadata. The final set of messages include contents of the individual messages communicated between participants within the social messaging application 102 (as modified by the user as discussed above). The related metadata includes a list of the participants involved in the conversation, the contact information for the participants, and any accompanying media such as audio, video, or image files. The electronic signature application 104 transmits the final set of messages and related metadata to the electronic signature server system 110. In addition, the electronic signature application 104 transmits the original set of messages and original metadata of the unmodified conversation to the electronic signature server system 110. The original, unedited conversation data is stored in the database storage 112 of the electronic signature server system 110 so that the original conversation is preserved and reproducible.

The electronic signature server system 110, upon receiving the final set of messages and related metadata, generates an electronic document between the participants. The electronic document includes a list of the final set of messages between the parties in chronological order. The electronic signature server system 110 also generates and embeds default legal provisions to the electronic document. For example, the default legal provisions specify that all participants agree to the contents of the electronic document and that the electronic document is the full and final agreement between the parties. A statement indicating that the electronic document was generated using conversations that took place in a social messaging application may also be included. Additionally, the electronic signature server system 110 further indicates in an audit history or other edit trail that the electronic document originated as a result of a social messaging application (and further identifies the social messaging application). The electronic signature server system 110 further inserts electronic signature fields for the participants and authenticates the identities of the participants in the manner described above. Upon receiving authenticated electronic signatures of the participants (i.e. via biometric reading input, username and password authentication, email confirmation, or other electronic signature mechanisms), the authenticated electronic document is transmitted over the network to all participants. For example, the authenticated electronic document is transmitted as a PDF to the email addresses of the participants or to the electronic signature applications 104a-b.

As described above, embodiments herein enable the generation of authenticated electronic documents based on terms discussed in direct messages passed between participants in a social messaging application. Electronic signature applications 104a-b extract conversation information from the social messaging application 102a. Upon being modified by a user of computing device 100a, the original and modified conversation information is provided to the electronic signature server system 110.

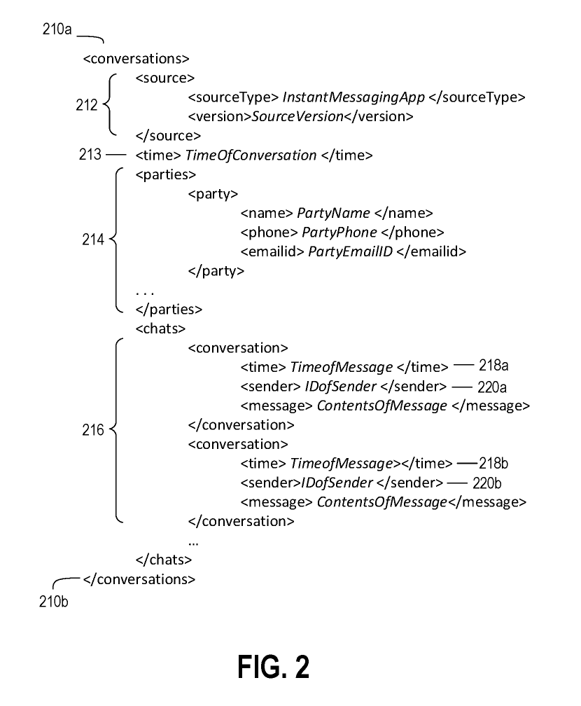

FIG. 2 is a sample data set that depicts the contents of conversation information transferred from social messaging application 102 to electronic signature application 104. For exemplary purposes, FIG. 2 shows the data set comprising conversation information for an instant messaging application. The contents of the information (conversation source, identification of the parties, time of transmittal for the direct messages, and the chronological listing of direct messages) are also found in conversation information for email communication.

The data set shown in FIG. 2 represents the information indicating the chronological list of direct messages and related metadata in one conversation, as shown by tags 210a-b. One conversation includes a grouping of instant messages passed between participants. The conversation information includes a source field 212 indicating information on the application used (e.g., the name of the instant messaging application and the version number). The conversation information also includes a time field 213 specifying the duration of time of the conversation (e.g., specified by a start time indicating the first direct message send and a stop time indicating the last direct message sent). The conversation information further includes a listing of the parties 214 (i.e. participants in the conversation), listed by name and contact information such as a phone number and email address.

The conversation information follows with a chronological list of direct messages 216. The chronological list of direct messages 216 include the direct messages between participants including the terms of an agreement discussed within the social messaging application. In some aspects, the chronological list of direct messages 216 is accompanied with information on the time of the messages 218a-b and identities of the senders of the messages 220a-b. The information in the source field 212, the time field 213, listing of the parties 214, time of the messages 218a-b, and senders of the messages 220a-b is referred to herein as metadata associated with the chronological list of direct messages.

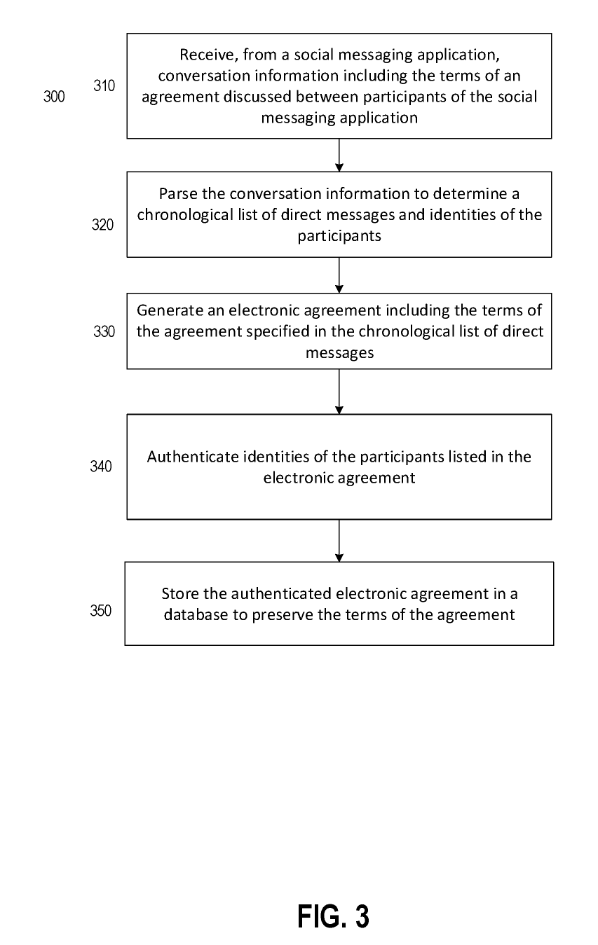

FIG. 3 is a flowchart depicting an example process 300 for generating an authenticated electronic document specifying terms of an agreement from direct messages passed between participants within a social messaging application. The process 300 may be performed by one or more of the components listed in FIG. 1 or by any other suitable component or in any suitable computing and/or communication environment.

The process 300 involves receiving from a social messaging application, conversation information including the terms of an agreement discussed between participants of the social messaging application, as shown in block 310. For example, if the social messaging application 102a comprises an instant messaging application as described above, upon completing an agreement over the instant messaging application, the instant messaging application 102a presents an option for sharing/transmitting conversation information with other applications stored on the computing device 100a. Upon receiving the option for transmitting the conversation information, the conversation information is provided via an electronic signature interface 106a to the electronic signature application 104a. In another embodiment, instead of transmitting conversation information from the instant messaging application to the electronic signature application 104a, a participant opens the electronic signature application 104a (i.e. computing device 100a executes code to bring electronic signature application 104a to the foreground of the user interface). The electronic signature application 104a presents one or more prompts for retrieving conversation information from a list of applications stored on the computing device 100a. One of the list of applications includes the instant messaging application that includes the conversation information specifying the terms of the agreement. Via selection of the instant messaging application from the one or more prompts displayed by the electronic signature application 104a, the electronic signature application 104a retrieves the conversation information from the selected instant messaging application via the electronic signature interface 106a.

In another embodiment, if the social messaging application 102a comprises an email application, and the conversation information is stored as a chain of emails passed between participants, the email client (i.e. the social messaging application 102a) provides a plugin, extension, or other software component that allows external applications (such as electronic signature application 104a) to interface with the email client. The plugin provides the interface for transmitting the conversation information from the email client (e.g., the chain of emails containing the terms of the agreement) to the electronic signature application 104a.

The process 300 further involves parsing the conversation information to determine a chronological list of direct messages and identities of the participants, as shown in block 320. For example, the electronic signature application 104a parses through the data set 210a to retrieve the chronological list of direct messages 216 and the identities of the participants 214. The identities of the participants include, for example, the name of the participant and contact information of the participants. In some aspects, the electronic signature application 104a further provides a user interface enabling a user of computing device 100a to remove or otherwise modify one or more of the direct messages.

The process 300 also includes generating an electronic document including the terms of the agreement specified in the chronological list of direct messages, as shown in block 330. For example, in one embodiment, the electronic signature application 104a generates an electronic document as a PDF document or as another electronic document format. In another embodiment, the electronic signature application 104a transmits the conversation information to the electronic signature server system 110 via network 115. Upon receiving the conversation information including the chronological list of direct messages and the identities of the participants, the electronic signature server system 110 converts the list of direct messages to an electronic document format such as a PDF document. The generated electronic document is an unauthenticated and informal electronic document that lists the complete conversation (as edited by the participants as described above) in chronological order. Names and contact information of the participants are added to a portion of the document reserved as a signature space (e.g., the end of a document). If contact information is not provided in the metadata extracted from the conversation information from the social messaging application 102, the electronic signature server system 110 retrieves previously stored identification and contact information for the participants and includes the identification and contact information in the electronic document. Further, the electronic signature server system 110 inserts a clause within the electronic document specifying default legal terms (e.g., that all participants agree to the contents and order of the conversation). In the signature space, the electronic signature server system 110 inserts a placeholder for the electronic signatures of the participants.

Process 300 further includes authenticating the identities of the participants, as shown in block 340. For example, the informal electronic document generated as described above is electronically transmitted over network 115 to computing devices 100a-b. Electronic signature applications 104a-b receive the informal electronic document and present user interfaces to the users of computing devices 100a-b for entering in authentication credentials. For example, authentication credentials include email confirmation, a user name and password, a biometric identification reading (e.g., a scanned fingerprint reading or iris/retina reading). Authentication credentials are referred to generally as electronic signatures. Upon receiving the authentication credentials/electronic signatures from the users of computing devices 100a-b, the electronic signature applications 104a-b transmit the authentication credentials/electronic signatures to the electronic signature server system 110. The electronic signature server system 110 cross-references the received authentication credentials with previously stored unique identifiers of the participants in database storage 112. If the received authentication credentials match the unique identifiers in database storage 112, the participant is authenticated. Upon authenticating all participants of the electronic document, the electronic signature server system 110 inserts digital signatures representing the signatures of the participants into the signature portion of the electronic document, thereby generating an authenticated electronic document. The authenticated electronic document is transmitted to computing devices 100a-b so that participants of the conversation receive copies of the authenticated electronic document.

The authenticated electronic document is stored in a database to preserve the terms of the agreement, as shown in block 350. For example, the authenticated electronic document is stored by the electronic signature server system 110 in database storage 112 for preservation. In some aspects, the original, unmodified conversation information (including the chronological list of direct messages and the identities of the parties) is also stored in database storage 112.

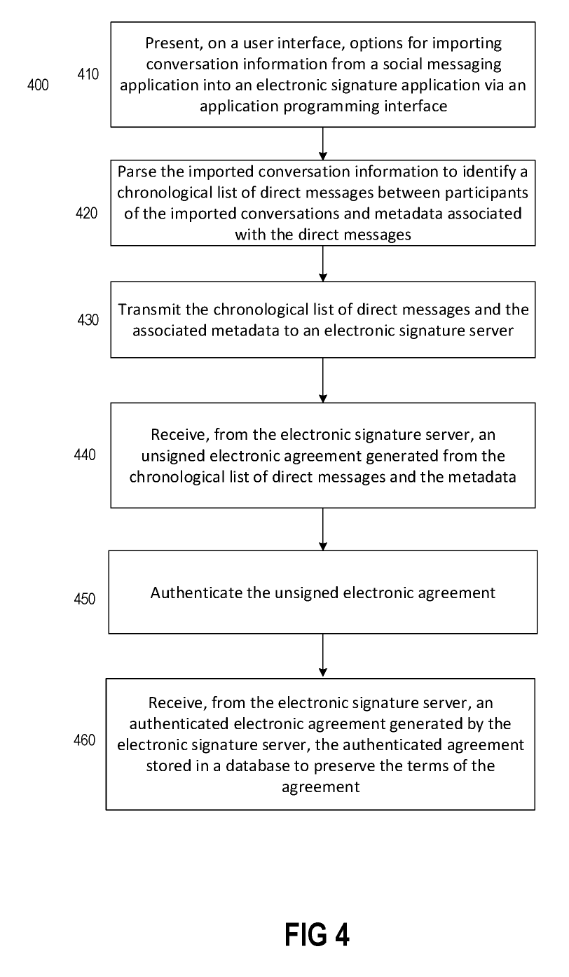

FIG. 4 is a flowchart depicting an example of an alternative process 400 for generating an authenticated electronic document specifying terms of an agreement from direct messages passed between participants within a social messaging application. The process 400 may be performed by one or more of the components listed in FIG. 1 or by any other suitable component or in any suitable computing and/or communication environment.

The process 400 includes presenting, on a user interface, options for importing conversation information from a social messaging application into an electronic signature application via an application programming interface, as shown in block 410. As described above, a user interface presented by the social messaging application 102 or from the electronic signature application 104 presents options for importing conversation information, which includes a chronological list of direct messages passed between participants as well as metadata related to the list of direct messages.

Upon receiving the conversation information from the social messaging application 102, the electronic signature application 104 parses the imported conversation information to identify a chronological list of direct messages between participants of the imported conversations and metadata associated with the direct messages, as shown in block 420. The electronic signature application 104, in some aspects, further displays on a user interface options for modifying or otherwise deleting one or more direct messages that are irrelevant to the terms of the agreement.

The electronic signature application 104 transmits the chronological list of direct messages and the associated metadata (as modified as well as the original, unedited list of direct messages and associated metadata) to the electronic signature server system 110, as shown in block 420. The electronic signature server system 110 converts the received list of direct messages and associated metadata into an informal electronic document. As described above with reference to FIG. 3, the electronic signature server system 110 copies the list of direct messages in chronological order to an electronic document such as a PDF. The electronic signature server system 110 further specifies the identity of the participant that provided the direct message. The electronic document thus specifies the terms of the agreement as discussed using the social messaging application 102. The electronic signature server system 110 further maps contact information of the participants into a signature portion of the electronic document (either retrieved from the received metadata or by cross-referencing participant information in database storage 112).

The electronic signature application 104 receives, from the electronic signature server system 110, the unsigned and informal electronic document, as shown in block 440.

The electronic signature application 104 and the signature server system 110 authenticate the unsigned electronic document via the process described above with reference to FIG. 3, as shown in block 450.

The electronic signature application 104 further receives, from the electronic signature server system 110, an authenticated electronic document generated by the electronic signature server system 110. The authenticated electronic document includes digital representations of the signatures of the participants and is provided to the participants via email or via electronic signature applications 102. For example, upon receiving a copy of the authenticated electronic document, the electronic signature application 102 presents a notification to the participant indicating that the signed and authenticated electronic document has been received. Via the process described above with reference to FIG. 3, the electronic signature server system 110 stores the authenticated electronic document as well as the original, unmodified electronic document in a database storage 112 to preserve the terms of the agreement.

Via the processes 300 and 400 described above, participants discussing terms of an agreement over an instant messaging application or via one or more chains of email messages are able to generate authenticated electronic documents without having to manually redraft the terms of the agreement discussed over the social messaging application. Embodiments disclosed herein further enable participants to retrieve the preserved set of direct messages and the final authenticated electronic document at a later time.

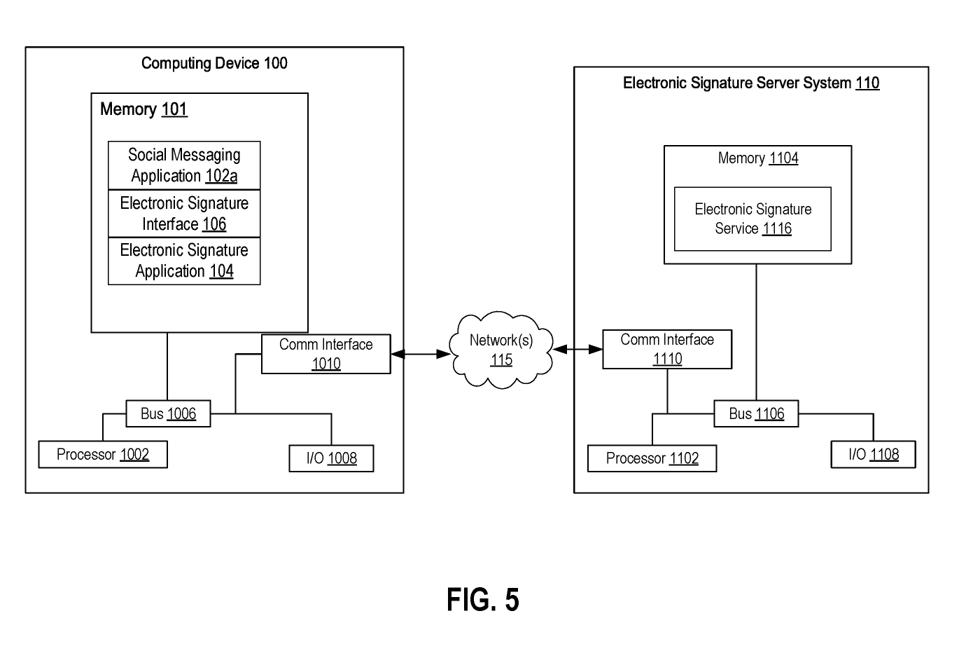

Any suitable computing system or group of computing systems can be used to implement the computing device 100 and electronic signature server system 110. For example, FIG. 5 is a block diagram depicting examples of implementations of such components. The computing device 100 includes a processor 1002 that is communicatively coupled to the memory 101 and that executes computer-executable program code and/or accesses information stored in the memory 101. The processor 1002 comprises, for example, a microprocessor, an application-specific integrated circuit (“ASIC”), a state machine, or other processing device. The processor 1002 includes one processing device or more than one processing device. Such a processor is included or may be in communication with a computer-readable medium storing instructions that, when executed by the processor 1002, cause the processor to perform the operations described herein.

The memory 101 includes any suitable non-transitory computer-readable medium. The computer-readable medium includes any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions include processor-specific instructions generated by a compiler and/or an interpreter from code written in any suitable computer-programming language, including, for example, C, C++, C#, Visual Basic, Java, Python, Perl, JavaScript, and ActionScript.

The computing device 100 also comprises a number of external or internal devices such as input or output devices. For example, the computing system 100 is shown with an input/output (“I/O”) interface 1008 that receives input from input devices or provide output to output devices. Display device 108, for example, is communicatively coupled to I/O interface 1008. A bus 1006 is also included in the computing system 100. The bus 1006 communicatively couples one or more components of the computing system 100.

The computing device 100 executes program code that configures the processor 1002 to perform one or more of the operations described above. The program code includes one or more of the social messaging application 102 and the electronic signature application 104. The program code also includes an electronic signature interface 106 for interfacing social messaging application 102 with electronic signature application 104. The program code is resident in the memory 101 or any suitable computer-readable medium and is executed by the processor 1002 or any other suitable processor. In some embodiments, the modules can be resident in the memory 101, as depicted in FIG. 5. In additional or alternative embodiments, one or more modules are resident in a memory that is accessible via a data network, such as a memory accessible to a cloud service.

The computing device 100 also includes a network interface device 1010. The network interface device 1010 includes any device or group of devices suitable for establishing a wired or wireless data connection to one or more data networks 115. Non-limiting examples of the network interface device 1010 include an Ethernet network adapter, a modem, and/or the like. The computing device 100 transmits messages as electronic or optical signals via the network interface device 1010. For example, the computing device 100 transmits the chronological list of direct messages and associated metadata, as described above with reference to FIGS. 1-4, to electronic signature server system 110 via network 115.

Similar to the computing device 100, the electronic signature server system 110 also includes a processor 1102, I/O interface 1108, communication interface 1110, and memory 1104 communicatively coupled via a bus 1106. The memory 1104 includes non-transitory computer-readable memory as described above and stores program code defining operations of the electronic signature server system 120. The processor 1102 executes the computer-executable program code and/or accesses information stored in the memory 1104. For example, electronic signature server system 110 includes memory 1104 that stores program code for an electronic signature service 1116. Upon execution by processor 1102, the program code for the electronic signature service 1116 performs the steps and functions for described above with respect to FIGS. 1-4. For example, the electronic signature service 1116 generates an electronic document from a received chronological list of direct messages and associated metadata from computing device 100. The electronic signature service 1116 also authenticates identities of the participants by communicating identification information with computing device 100. The electronic signature service 1116 further stores the authenticated electronic document in a database storage 112.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method for generating an authenticated electronic document specifying terms of an agreement from direct messages passed between participants within a social messaging application, the method comprising:
receiving, from a social messaging application, conversation information including the terms of an agreement discussed between participants of the social messaging application via a chronological list of direct messages passed between the participants;
parsing the conversation information to determine the chronological list of direct messages and identities of the participants;
generating, based on the chronological list of direct messages and the identities of the participants, an electronic document including the terms of the agreement specified in the chronological list of direct messages and a list of the participants;
generating an authenticated electronic document comprising the terms of the agreement by authenticating identities of the participants; and
storing the authenticated electronic document in a database to preserve the terms of the agreement.

2. The method of claim 1, further comprising:
receiving, on a user interface, selections for deleting one or more messages from the chronological list of direct messages, the one or more messages including information irrelevant to the terms of the agreement;
deleting the one or more messages indicated by the received selections to generate a modified chronological list of direct messages;
generating, based on the modified chronological list of direct messages and the identities of the participants, a modified electronic document including the terms of the agreement specified in the modified chronological list of direct messages
generating a modified authenticated electronic document comprising the terms of the agreement by authenticating identities of the participants by communicating with the electronic signature service; and
storing the modified authenticated electronic document in the database to preserve the terms of the agreement.

3. The method of claim 1, wherein the social messaging application comprises an instant messaging application, and wherein the chronological list of direct messages between the participants comprise a sequence of real-time text or data transmissions communicated over a network.

4. The method of claim 1, wherein the social messaging application comprises an email application, and wherein the chronological list of direct messages between the participants comprise a sequence of separate email messages communicated by the individual participants.

5. The method of claim 1, further comprising:
receiving user input specifying a start time and an end time for the conversation information,
wherein parsing the conversation information to determine the chronological list of direct messages includes filtering the chronological list of direct messages according to the start time and the end time specified by the user input.

6. The method of claim 1, wherein generating the electronic document includes inserting pre-determined legal provisions with the terms of the agreement specified in the chronological list of direct messages and the list of the participants.

7. The method of claim 1, wherein parsing the conversation information to determine the identities of the participants includes determining contact information of the participants, and wherein generating the electronic document includes automatically including the contact information of the participants within the electronic document.

8. A method for intelligently extracting data from a social messaging application to automatically facilitate the generation of electronic documents for electronic signature, the method including:
presenting, on a user interface, options for importing conversation information relating to an agreement from a social messaging application into an electronic signature application via an application programming interface;
receiving, from the user interface, a selected option for importing conversation information, the conversation information including a chronological list of direct messages between participants of imported conversations and metadata associated with the chronological list of direct messages;
importing, by the processing device, the conversation information, the imported conversation information including terms of the agreement discussed between participants via the social messaging application;
extracting, by the processing device, message and identity data relating to the agreement from the imported conversation information, wherein extracting the message and identity data comprises:
parsing the imported conversation information, and
identifying, from the parsed conversation information, a chronological list of direct messages between participants of the imported conversations and metadata associated with the chronological list of direct messages, the metadata including identities of the participants;
transmitting, by the processing device and to an electronic signature server, the extracted message and identity data relating to the agreement comprising the chronological list of direct messages between participants and the metadata associated with the chronological list of direct messages;
receiving, from the electronic signature server, an unsigned electronic document that is generated from (i) the chronological list of direct messages and (ii) the metadata by the electronic signature server;
receiving, from at least one user, authentication credentials verifying the user's identity;
transmitting, by the processing device, the authentication credentials to the electronic signature server for the purpose of authentication; and
receiving, from the electronic signature server, an authenticated electronic document generated by the electronic signature server, the authenticated electronic document corresponding to the unsigned electronic document, the authenticated electronic document stored in a database to preserve the terms of the agreement.

9. The method of claim 8, wherein the chronological list of direct messages transmitted to the electronic signature server include modifications or deletions of individual messages irrelevant to the terms of the agreement, the modifications or deletions of individual messages specified by selections received via the user interface.

10. The method of claim 8, wherein the social messaging application comprises an instant messaging application, and wherein the chronological list of direct messages between the participants comprise a sequence of real-time text or data transmissions communicated over a network.

11. The method of claim 8, wherein the social messaging application comprises an email application, and wherein the chronological list of direct messages between the participants comprise a sequence of separate email messages communicated by the individual participants.

12. The method of claim 8, wherein transmitting the authentication credentials comprises:
receiving, via the user interface, the electronic signatures from the participants; and
transmitting the electronic signatures to the electronic signature server, wherein the electronic signature server authenticates the identities of the participants by email confirmation.

13. The method of claim 8, wherein the metadata associated with the chronological list of direct messages includes identities of the participants including names and email addresses of the participants and timestamps of individual messages of the chronological list of direct messages.

14. The method of claim 13, wherein the authenticated electronic document includes the names and the email addresses of the participants in a signature section of the authenticated electronic document.

15. A non-transitory computer-readable medium with program code stored thereon, wherein the program code is executable to perform operations comprising:
presenting, on a user interface, options for importing conversation information relating to an agreement from a social messaging application into an electronic signature application via an application programming interface;
receiving, from the user interface, a selected option for importing conversation information, the conversation information including a chronological list of direct messages between participants of imported conversations and metadata associated with the chronological list of direct messages;
importing, by the processing device, the conversation information, the imported conversation information including terms of the agreement discussed between participants via the social messaging application;
extracting, by the processing device, message and identity data relating to the agreement from the imported conversation information, wherein extracting the message and identity data comprises:
parsing the imported conversation information, and
identifying, from the parsed conversation information, a chronological list of direct messages between participants of the imported conversations and metadata associated with the chronological list of direct messages, the metadata including identities of the participants;
transmitting, by the processing device and to an electronic signature server, the extracted message and identity data relating to the agreement comprising the chronological list of direct messages between participants and the metadata associated with the chronological list of direct messages;
receiving, from the electronic signature server, an unsigned electronic document that is generated from (i) the chronological list of direct messages and (ii) the metadata by the electronic signature server;
receiving, from at least one user, authentication credentials verifying the user's identity;
transmitting, by the processing device, the authentication credentials to the electronic signature server for the purpose of authentication; and
receiving, from the electronic signature server, an authenticated electronic document generated by the electronic signature server, the authenticated electronic document corresponding to the unsigned electronic document, the authenticated electronic document stored in a database to preserve the terms of the agreement.

16. The non-transitory computer-readable medium of claim 15, wherein the chronological list of direct messages transmitted to the electronic signature server include modifications or deletions of individual messages irrelevant to the terms of the agreement, the modifications or deletions of individual messages specified by selections received via the user interface.

17. The non-transitory computer-readable of claim 15, wherein the social messaging application comprises an instant messaging application, and wherein the chronological list of direct messages between the participants comprise a sequence of real-time text or data transmissions communicated over a network.

18. The non-transitory computer-readable medium of claim 15, wherein the social messaging application comprises an email application, and wherein the chronological list of direct messages between the participants comprise a sequence of separate email messages communicated by the individual participants.

19. The non-transitory computer-readable medium of claim 15, wherein the metadata associated with the chronological list of direct messages includes identities of the participants including names and email addresses of the participants and timestamps of individual messages of the chronological list of direct messages.

20. The non-transitory computer-readable medium of claim 19, wherein the authenticated electronic document includes the names and the email addresses of the participants in a signature section of the authenticated electronic document.
